(19) United States
(12) Patent Application Publication
(10) Pub. No.: US 2025/0114958 A1
(43) Pub. Date: Apr. 10, 2025

(54) FOLDABLE CARTRIDGE RAZOR

(71) Applicants: Namkyoo KANG, Seoul (KR); Hyeon Kyoo KANG, Gunsan-si (KR)

(72) Inventors: Namkyoo KANG, Seoul (KR); Hyeon Kyoo KANG, Gunsan-si (KR)

(21) Appl. No.: 18/884,247

(22) Filed: Sep. 13, 2024

(30) Foreign Application Priority Data
Oct. 5, 2023 (KR) 10-2023-0132928

(51) Int. Cl. B26B 21/52; B26B 21/22

(52) U.S. Cl. CPC B26B 21/521; B26B 21/225; B26B 21/523

(57) ABSTRACT

The present disclosure relates to a foldable cartridge razor which may improve shaving performance and enhance safety, portability, and hygiene by folding and concealing a head part of a razor blade and includes a handle having a fitting piece formed therein, a neck part rotatably connected to a fitting piece of the handle and a razor blade head detachably and rotatably connected to a neck part so that the razor blade is folded to be in close contact with the inside of the handle.

### CROSS-REFERENCE TO RELATED APPLICATIONS

This application claims the priority of the Korean Patent Application NO 10-2023-0132928, filed on Oct. 5, 2023, in the Korean Intellectual Property Office. The entire disclosures of all these applications are hereby incorporated by reference.

### TECHNICAL FIELD

The present disclosure relates to a foldable cartridge razor, and more particularly, to a foldable cartridge razor in which shaving performance is improved and improvement of safety, convenience of portability, and a hygiene level is possible by folding a head part of a razor blade.

### DESCRIPTION OF THE RELATED ART

Generally, razors are used for shaving facial hair, beard, sideburns, and other body hairs, are composed of razor blade cartridges including handles configured to be gripped and razor blades which come into contact with the skin and perform shaving, and have a replaceable type in which a handle and a cartridge are separated or an integral type in which a handle and a cartridge are fixed.

Although razor blade cartridges usually include a double edge composed of two razor blades, in recent year, they include three or more razor blades.

Such razors are configured to keep users in clean states, for example, by, if a razor blade cartridge having two razor blades is installed, first cutting long hairs using one razor blade, and then cutting the already cut hairs even shorter using the remaining razor blade.

Also, in the case of reusable razors which are widely used at home, a user may use them semi-permanently by simply replacing the razor blade cartridge after purchasing them once.

Such razors in the related art have drawbacks in that, since the razor blade cartridges having the razor blades are directly joined to the handles, the razor blade cartridges have poor left-right flexibility, and thus users need to bend their wrists or change the positions of the razors frequently in accordance with the region to be shaved, making shaving very uncomfortable.

Among razors in the related art, when rotating parts in which the rotation of the razor blade cartridges is possible are provided, there are disadvantages to using springs or steel in the rotating parts, making it complex to produce and difficult to recycle.

Furthermore, since the razor blade is exposed to the outside, a cover needs to be put on the razor blade for safety, which is inconvenient, and if there is no cover to put on the razor blade, there is a risk of accidents caused due to the cutting of the skin by the razor blade as the razor blade is exposed to the outside.

In addition, there is a disadvantage in that a lot of moisture remains on the razor blade after using the razor, which is not hygienic.

Moreover, since razors in the related art do not have a structural means for fixing the razor, they require a separate razor case or are difficult to input when carried in a bag.

Also, there is a disadvantage in that, when shaving a face with a convex curve in a state in which several razor blades are places in contact with a flat surface, only a certain part of the razor blade comes into contact with the face, the smaller the area of the razor blade used for shaving, the less close contact there is with the shaving surface.

### DOCUMENTS IN RELATED ART

### Patent Document

(Patent Document 1) Korean Registration Patent Publication No. 10-2567174

### DISCLOSURE OF THE INVENTION

### Technical Goals

The present disclosure was made to solve the above problems and may improve shaving performance by connecting a razor blade head having a razor blade to a neck part having elasticity so that the razor blade head elastically deforms in three axes and the razor blade comes into contact with the surface of the face in an even manner even with a small amount of wrist rotation.

Also, the present disclosure may improve productivity, reduce weight, and facilitate recycling by unifying the material of the razor neck part and making producing easier.

Furthermore, the present disclosure shows that the neck part to which the razor blade head is connected can be folded so that the razor blade is accommodated in the handle, eliminating the need for a separate cover to cover the razor blade, thereby improving portability and safety.

In addition, the present disclosure significantly reduces remaining moisture on the razor blade after using the razor by blowing it away with high-velocity air.

Moreover, the present disclosure has a structure which allows it to be safely installed in or attached to a bag or clothing.

Also, the present disclosure is for the purpose of providing a foldable cartridge razor in which the razor blade is configured to have a concave curve so that the razor blade comes into contact with a convex face in a well manner, thereby improving shaving performance.

### Technical Solutions

A foldable cartridge razor according to an example embodiment of the present disclosure for achieving the above purpose may include a handle having a fitting piece formed therein; a neck part rotatably connected to the fitting piece of the handle; and a razor blade head which is rotatably connected to the neck part and folded so that the razor blade comes into close contact with an inside of the handle.

Also, a concave part in which a razor blade head including a razor blade is seated may be formed in the handle.

On the other hand, the concave part may be formed so that a gap between the razor blade and the concave part gradually narrows in a direction of the razor blade in a state in which the razor blade is folded and an inclination is formed.

Furthermore, the neck part may have a fitting groove formed on one side into which a fitting piece is inserted and a head connection piece formed on the other side to which a razor blade head is detachably connected.

At this time, the head connection piece may have a cut portion formed so that a part thereof are cut up and down and a concave groove is formed in the inside.

Along with this, a curved elastic neck which provides elasticity may be formed in the neck part.

In addition, the elastic neck may be composed of a primary wrinkle whose winding shape is deformed in an upward/downward direction and a secondary wrinkle whose winding shape is deformed in a leftward/rightward direction.

At this time, a width of the elastic neck may increase from the razor blade head toward the handle.

Moreover, a connection part to which the razor blade is connected may be formed in the razor blade head and a head joint part is formed so that the neck part is connected to the connection part.

In addition, the head joint part may be formed to be inclined at an angle of 50 to 70° with respect to a longitudinal direction of the connection part.

Also, a head joint piece which is fitted into the head connection piece of the neck part may be formed in the head joint part, a locking projection may be formed on an upper part of the head joint piece so that it does not fall out when fitted into the head connection piece, and a protrusion piece may be formed on the side of the head joint piece.

On the other hand, the connection part into which the above razor blade is fitted may be formed in a form ion which it is allowed to be detachably connected from the head joint part.

Furthermore, the razor blade head may be formed in a concave shape on a surface facing a face to increase adhesion to the face.

Moreover, the handle may include a clip.

In addition, the clip may include support clip protrusions.

In addition, the connection part into which the razor blade is fitted may be formed in a form which is detachably connected from the head joint part.

As seen above, according to one example of the present disclosure, the razor blade head with the razor blade inserted is installed in the concave part of the handle to reduce the volume and prevent the razor blade from being exposed to the outside, thereby improving the convenience and safety of carrying and the razor blade may be managed hygienically. In addition, the razor blade head is connected to an elastic neck part to increase the adhesion between the razor blade and the face, thereby improving shaving performance.

In addition, the neck part and the handle may be produced through injection molding each using the same plastic material, which can significantly reduce the production process, reduce weight, and facilitate recycling.

### BRIEF DESCRIPTION OF THE DRAWINGS

FIG. 1 is a perspective view illustrating a foldable cartridge razor according to the present disclosure.

FIG. 2 is an exploded perspective view illustrating a foldable cartridge razor according to the present disclosure.

FIG. 3 is a side view illustrating a foldable cartridge razor according to the present disclosure.

FIG. 4 is a front view illustrating a foldable cartridge razor according to the present disclosure.

FIG. 5 is a plan view illustrating a foldable cartridge razor according to the present disclosure.

FIG. 6 is a perspective view illustrating a foldable cartridge razor in a folded state according to the present disclosure.

FIG. 7 is a side view illustrating a foldable cartridge razor according to the present disclosure in a folded state.

FIG. 8 is a plan view illustrating a foldable cartridge razor according to the present disclosure in a folded state.

FIG. 9 is a bottom view illustrating a foldable cartridge razor according to the present disclosure in a folded state.

FIG. 10 is a cross-sectional view taken along line ‘A-A’ of FIG. 7.

FIG. 11 is a perspective view illustrating a neck part of the foldable cartridge razor according to the present disclosure.

FIG. 12 is a side view illustrating the neck part of the foldable cartridge razor according to the present disclosure.

FIG. 13 is a front view illustrating the neck part of the foldable cartridge razor according to the present disclosure.

FIG. 14 is a plan view illustrating the neck part of the foldable cartridge razor according to the present disclosure.

FIG. 15 is a front view illustrating a razor blade head of the foldable cartridge razor according to the present disclosure.

FIG. 16 is a cross-sectional view illustrating a connection state of a head connection piece and a head joint piece in an unfolded state of the foldable cartridge razor according to the present disclosure.

FIG. 17 is a cross-sectional view illustrating the connection state of the head connection part and the head joint part in a folded state of the foldable cartridge razor according to the present disclosure.

FIG. 18 is an exploded perspective view illustrating the connection part and the head joint part into which a razor blade of the foldable cartridge razor is fitted according to the present disclosure.

### DETAILED DESCRIPTION FOR CARRYING OUT THE INVENTION

Preferred embodiments of the present disclosure will be described in detail below with reference to the attached drawings. The features and advantages of the present disclosure and the means for implementing them will become apparent through the detailed description of the embodiments together with the attached drawings. Here, the embodiments of the present disclosure which will be described below are merely exemplary and are not intended to limit the scope of the present disclosure to the described embodiments. Furthermore, constituent elements of each of the embodiments may be combined in various ways within the example embodiment or between the example embodiments, as long as there is no other mention or contradiction between them.

Also, when it is said that a part “includes” a constituent element, it is meant that it necessarily includes that constituent element, regardless of other constituent elements, not that excluding the addition of other constituent elements is intended.

Furthermore, throughout the specification, when a part is said to be “connected” to another part, this includes not only “directly connected” but also “indirectly” or “electrically connected” with other members or components in between.

In addition, throughout the specification, the description that each layer (film), region, pattern or structure is formed “on” or “under” the substrate, each layer (film), region, pad or pattern includes both being formed directly or via intervening other layers. The criteria for being on/over or under/under each layer are explained with reference to the drawings.

Expressions such as ‘first, second’, and the like are only used for distinguishing between a plurality of components and do not limit the order or other characteristics between the components.

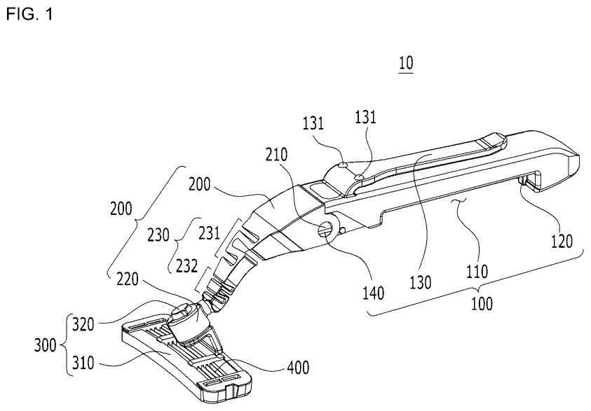

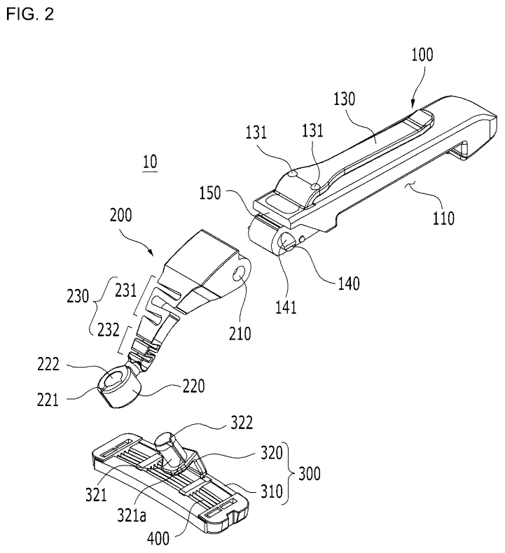

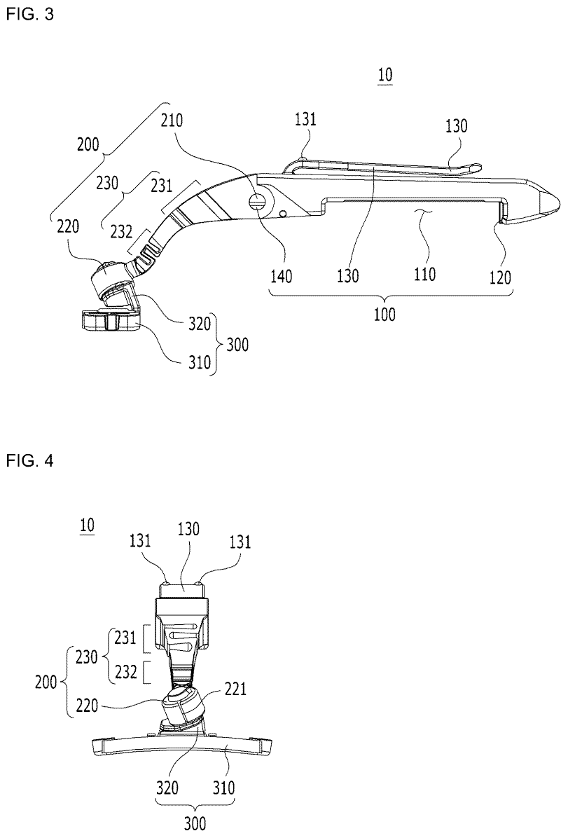

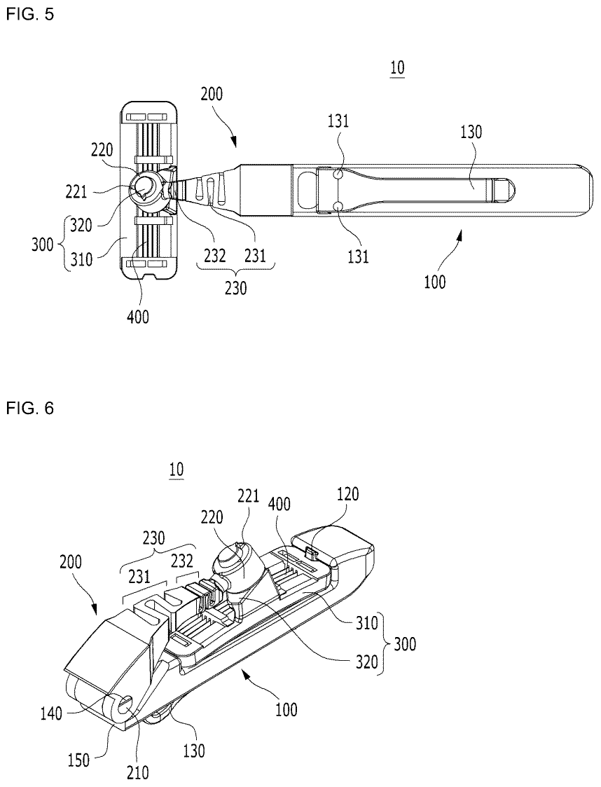

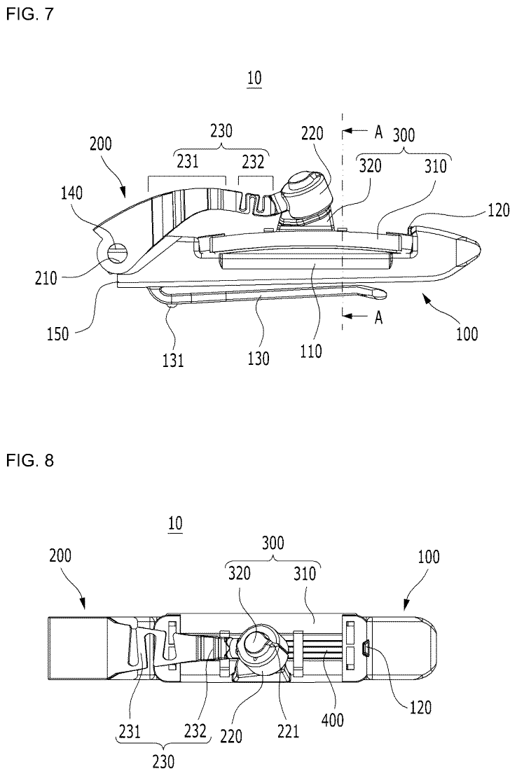

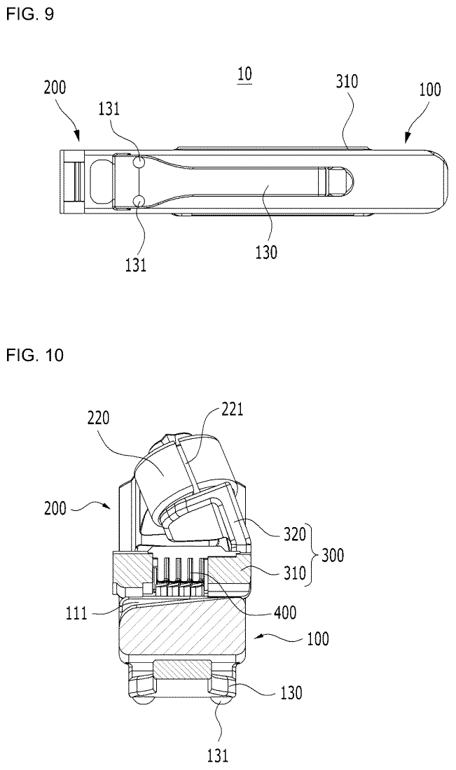

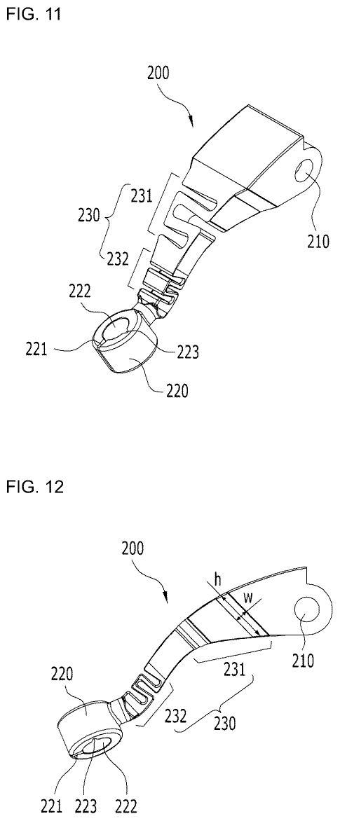

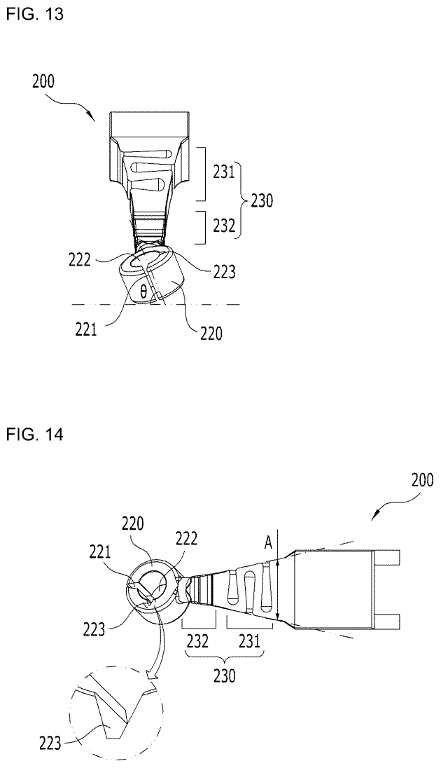

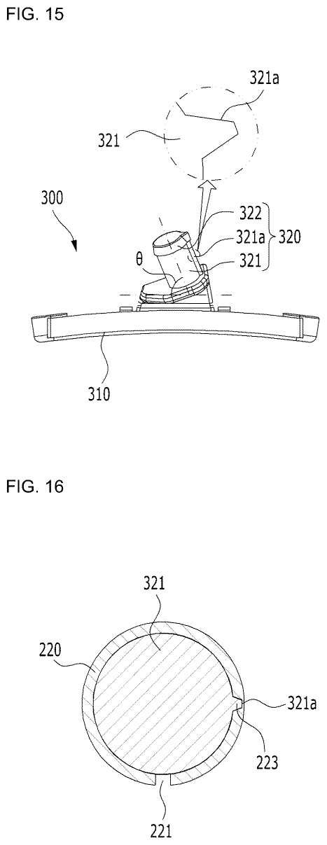

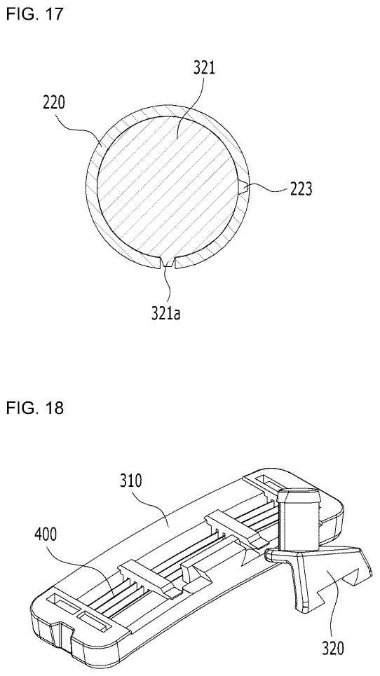

FIG. 1 is a perspective view illustrating a foldable cartridge razor according to the present disclosure. FIG. 2 is an exploded perspective view illustrating a foldable cartridge razor according to the present disclosure. FIG. 3 is a side view illustrating a foldable cartridge razor according to the present disclosure. FIG. 4 is a front view illustrating a foldable cartridge razor according to the present disclosure. FIG. 5 is a plan view illustrating a foldable cartridge razor according to the present disclosure. FIG. 6 is a perspective view illustrating a foldable cartridge razor in a folded state according to the present disclosure. FIG. 7 is a side view illustrating a foldable cartridge razor according to the present disclosure in a folded state. FIG. 8 is a plan view illustrating a foldable cartridge razor according to the present disclosure in a folded state. FIG. 9 is a bottom view illustrating a foldable cartridge razor according to the present disclosure in a folded state. FIG. 10 is a cross-sectional view taken along line ‘A-A’ of FIG. 7. FIG. 11 is a perspective view illustrating a neck part of the foldable cartridge razor according to the present disclosure. FIG. 12 is a side view illustrating the neck part of the foldable cartridge razor according to the present disclosure. FIG. 13 is a front view illustrating the neck part of the foldable cartridge razor according to the present disclosure. FIG. 14 is a plan view illustrating the neck part of the foldable cartridge razor according to the present disclosure. FIG. 15 is a front view illustrating a razor blade head of the foldable cartridge razor according to the present disclosure. FIG. 16 is a cross-sectional view illustrating a connection state of a head connection piece and a head joint piece in an unfolded state of the foldable cartridge razor according to the present disclosure. FIG. 17 is a cross-sectional view illustrating the connection state of the head connection part and the head joint part in a folded state of the foldable cartridge razor according to the present disclosure. FIG. 18 is an exploded perspective view illustrating the connection part and the head joint part into which a razor blade of the foldable cartridge razor is fitted according to the present disclosure.

As shown in FIGS. 1 to 5, a foldable cartridge razor 10 according to the present disclosure may include a handle 100, a neck part 200, and a razor blade head 300.

Referring to FIGS. 2 and 3, the handle 100 may be formed to be long in a longitudinal direction so that a user may hold it with his or her hand at the time of shaving.

Also, a concave part 110 in which the razor blade head 300 to which a razor blade 400 is connected is seated may be formed in an inner surface of the handle 100. At this time, the concave part 110 may be formed to have a size in which it may accommodate the razor blade head 300. On the other hand, the concave part 110 may be formed to have a length in which it is equal to or longer than a length of the razor blade head 300 so that the razor blade head 300 may be smoothly seated.

Referring to FIG. 10, a flow path 111 may be formed in the concave part 110 so that a gap between the razor blade 400 and the concave part 110 gradually narrows toward the razor blade 400 and an inclination is formed such that the discharge of foreign substances such as hair and beard stuck in the razor blade 400 is facilitated in a state in which the razor blade head 300 including the razor blade 400 is folded and seated in the concave part 110. In this way, the concave part 110 forms a flow path 111 which gradually narrows toward the razor blade 400 so that the introduced air flow passes through the narrowed gap at a high speed in accordance with the Bernoulli's principle. Thus, by forming a lower pressure than the outside of the razor blade 400, water and foreign substances caught in the razor blade 400 may be smoothly discharged.

Referring to FIGS. 3 and 6, a support protrusion piece 120 may be formed on the side of the concave part 110 to prevent the razor blade head 300 from easily coming off while seated on the concave part 110. At this time, it is preferable that the support protrusion piece 120 be formed on one side of the concave part 110.

In addition, a clip 130 may be provided on the outer surface of the handle 100 for convenience of carrying. Furthermore, a plurality of support clip protrusions 131 may be formed on both sides of the outer surface of the clip 130 to stably hold the foldable cartridge razor 10. In this way, by forming the support clip protrusions 131, the folded cartridge razor 10 may be stably supported on the floor surface and prevented from falling over to the side.

Referring to FIGS. 1 and 2, fitting pieces 140 configured to connect the neck part 200 may be formed on both sides of the handle 100. At this time, the fitting pieces 140 may have inclined surfaces 141 formed below it so that the neck part 200 may be smoothly connected.

Furthermore, rotation-proof surfaces 150 may be formed on the upper parts of the fitting pieces 140 so that the side of the neck part 200 may be caught while the neck part 200 is connected. Thus, the neck part 200 connected to the handle 100 is joined so that it can only rotate in the direction of the concave part 110.

The neck part 200 may be rotatably connected to the handle 100.

Referring to FIG. 1, the neck part 200 may have fitting grooves 210 formed in both sides of one side thereof into which the fitting pieces 140 are fitted and a head connection piece 220 to which the razor blade head 300 is detachably connected may be formed on the other side thereof.

Also, referring to FIGS. 11 and 14, the head connection piece 220 may have a cut portion 221 formed so that a part thereof is cut vertically, an installation groove 222 may be formed therein for connecting the razor blade head 300, and a trapezoidal concave groove 223 may be formed on the side of the installation groove 222. Thus, the head connection piece 220 is produced using an elastic material so that the head joint part 320 of the razor blade head 300 which will be described below may be easily installed when the cut portion 221 is opened by force.

On the other hand, referring to FIG. 13, the head connection piece 220 may be formed to be inclined at an angle θ of 50 to 70° from the longitudinal direction of the razor blade head 300.

Referring to FIGS. 11 to 14, the neck part 200 may be formed as an elastic neck 230 having a twisted shape to impart elasticity. Furthermore, the elastic neck 230 may be formed of a primary wrinkle 231 whose twisted shape is deformed in an upward/downward direction and a secondary wrinkle 232 whose twisted shape is deformed in a leftward/rightward direction in connection with the primary wrinkle 231.

Also, a width A of the elastic neck 230 may increase from the razor blade head 300 toward the handle 100.

Referring to FIG. 12, the elastic neck 230 may be formed so that a length h in the cross-section in the vertical direction relative to the handle 100 is longer than a length w of the cross-section in the direction of the handle 100.

The razor blade head 300 is connected to the razor blade 400 so that shaving may be performed through the razor blade 400 and is detachably and rotatably connected to the neck part 200 so that the razor blade 400 may be folded in close contact with the concave part 110 of the handle 100.

Referring to FIGS. 1 and 2, the razor blade head 300 may include a connection part 310 to which the razor blade 400 is connected and a head joint part 320 configured to connect the neck part 200 may be provided on the upper portion of the connection part 310.

Referring to FIGS. 4 and 15, the connection part 310 may be formed in a curved shape. Furthermore, the razor blade 400 inserted into the connection part 310 may also be formed into a curved shape together with the connection part 310. Thus, the connection part 310 and the razor blade 400 may form a curved surface so that the razor blade 400 comes into wide contact with the face, thereby increasing the sealing.

A head joint piece (321) which is fitted into the head connection piece 220 of the neck part 200 may be formed in the head joint part 320 and a locking projection 322 may be formed on the upper part of the head joint piece 321 to prevent it from coming off while fitted into the head connection piece 220.

Also, a protrusion piece 321a which fits into the concave groove 223 and a cut portion 221 in accordance with rotation may be formed on the side of the head joint piece 321. That is to say, referring to FIG. 16, when the head joint part 320 is joined to the head connection piece 220 so that the razor blade head 300 is connected to the neck part 200, the protrusion piece 321a is fitted into the concave groove 223 to prevent rotation. In addition, referring to FIG. 17, when the user wants to seat the razor blade head 300 on the concave part 110, if the user rotates the razor blade head 300, the head joint part 320 rotates due to the elasticity of the head connection piece 220 and the protrusion piece 321a comes out of the concave groove 223 and is fitted into the cut portion 221. At this time, the protrusion piece 321a may be formed in a trapezoidal shape. This can prevent rotation of the head joint piece 321.

Referring to FIG. 15, the head joint part 320 may be formed to be inclined at an angle θ of 50 to 70° with respect to the longitudinal direction of the connection part 310. On the other hand, if the angle θ exceeds this range, the razor blade head 300 may not be accurately seated on the concave part 110 in the folded state.

On the other hand, referring to FIG. 18, the connection part 310 into which the razor blade 400 is fitted is detachably separated from the head joint part 320, thereby enabling the replacement of the razor blade 400. At this time, it is desirable that the connection part 310 be installed in the head joint part 320 in various ways such as a fitting method or a clamp method.

As described above, in the present disclosure, the fitting groove 210 of the neck part 200 may be joined to the fitting pieces 140 of the handle 100 and the neck part 200 may be folded while rotating around the fitting pieces 140. In addition, the head joint part 320 may be joined to the head connection piece 220 of the above neck part 200 so that the razor blade head 300 into which the razor blade 400 is fitted may be rotatably connected to the neck part 200. Thus, as the razor blade head 300 rotates and the neck part 200 rotates, the razor blade head 300 is seated in the concave part 110 of the handle 100 so that the razor blade 400 is not exposed to the outside.

In this way, the neck part 200 and the razor blade head 300 are unfolded from the handle 100 to perform shaving using the razor blade 400, and when the foldable cartridge razor 10 is not in use, the neck part 200 and the razor blade head 300 are folded so that the razor blade 400 is accommodated in the concave part 110, thereby reducing the volume and allowing safe carrying and storage without accidents caused due to the razor blade 400.

Also, the neck part 200 is rotatably connected to the handle 100 and the neck part 200 has the elastic neck 230 having a twisted shape and formed of a first wrinkle 231 in an upward/downward direction and a second wrinkle 232 in a leftward/rightward direction. Thus, depending on the elasticity of the elastic neck 230, the razor blade head 300 is flexibly elastically deformed in three axes so that the razor blade 400 may adapt to the angle of the face and make maximum contact, thereby increasing shaving efficiency.

Furthermore, the neck part 200 formed in a twisted manner as described above serves to prevent or delay the shaving liquid applied to the razor blade during shaving from flowing directly from the razor blade head 300 toward the handle 100.

In the detailed description of the present disclosure above, only specific embodiments thereof are described. Here, it should be understood that the present disclosure is not limited to the particular forms set forth in the detailed description, but rather is to be understood to include all modifications, equivalents, and alternatives falling within the spirit and scope of the present disclosure as defined by the appended claims.

That is to say, the present disclosure is not limited to the specific embodiments and descriptions described above, and anyone with ordinary skill in the art to which the present disclosure belongs can make various modifications without departing from the gist of the present disclosure claimed in the claims, and such modifications are within the scope of protection of the present disclosure.

### EXPLANATION OF SYMBOLS

10: Foldable cartridge razor
100: Handle
110: Concave part
111: Flow path
120: Support protrusion piece
130: Clip
131: Support clip protrusion
140: Fitting piece
141: Inclined surface
150: Rotation-proof surface
200: Neck part
210: Fitting groove
220: Head connection piece
221: Cut portion
222: Installation groove
223: Concave groove
230: Elastic neck
231: Primary wrinkle
232: Secondary wrinkle
300: Razor blade head
310: Connection part
320: Head joint part
321: Head joint piece
321a: Protrusion piece
322: Locking projection
400: Razor blade

What is claimed is:

1. A foldable cartridge razor, comprising:
a handle having a fitting piece formed therein;
a neck part rotatably connected to the fitting piece of the handle; and
a razor blade head which is rotatably connected to the neck part and folded so that the razor blade comes into close contact with an inside of the handle.

2. The foldable cartridge razor of claim 1, wherein a concave part in which a razor blade head including a razor blade is seated is formed in the handle.

3. The foldable cartridge razor of claim 2, wherein the concave part is formed so that a gap between the razor blade and the concave part gradually narrows in a direction of the razor blade in a state in which the razor blade is folded and an inclination is formed.

4. The foldable cartridge razor of claim 1, wherein the neck part has a fitting groove formed on one side into which a fitting piece is inserted and a head connection piece formed on the other side to which a razor blade head is detachably connected.

5. The foldable cartridge razor of claim 4, wherein the head connection piece has a cut portion formed so that a part thereof are cut up and down and a concave groove is formed in the inside.

6. The foldable cartridge razor of claim 1, wherein a curved elastic neck which provides elasticity is formed in the neck part.

7. The foldable cartridge razor of claim 6, wherein the elastic neck is composed of a primary wrinkle whose winding shape is deformed in an upward/downward direction and a secondary wrinkle whose winding shape is deformed in a leftward/rightward direction.

8. The foldable cartridge razor of claim 6, wherein a width of the elastic neck increases from the razor blade head toward the handle.

9. The foldable cartridge razor of claim 1, wherein a connection part to which the razor blade is connected is formed in the razor blade head and a head joint part is formed so that the neck part is connected to the connection part.

10. The foldable cartridge razor of claim 9, wherein the head joint part is formed to be inclined at an angle of 50 to 70° with respect to a longitudinal direction of the connection part.

11. The foldable cartridge razor of claim 9, wherein a head joint piece which is fitted into the head connection piece of the neck part is formed in the head joint part, a locking projection is formed on an upper part of the head joint piece so that it does not fall out when fitted into the head connection piece, and a protrusion piece is formed on the side of the head joint piece.

12. The foldable cartridge razor of claim 9, wherein the connection part into which the above razor blade is fitted is formed in a form in which it is allowed to be detachably connected from the head joint part.

13. The foldable cartridge razor of claim 1, wherein the razor blade head is formed in a concave shape on a surface facing a face to increase adhesion to the face.

14. The foldable cartridge razor of claim 1, wherein the handle includes a clip.

15. The foldable cartridge razor of claim 14, wherein the clip includes support clip protrusions.
